(19) United States
(12) Patent Application Publication
(10) Pub. No.: US 2015/0145722 A1
(43) Pub. Date: May 28, 2015

(54) USING SBAS IONOSPHERIC DELAY MEASUREMENTS TO MITIGATE IONOSPHERIC ERROR

(71) Applicant: Honeywell International Inc., Morristown, NJ (US)

(72) Inventors: Bruce G. Johnson, Shoreview, MN (US); Kim A. Class, Andover, MN (US)

(73) Assignee: Honeywell International Inc., Morristown, NJ (US)

(21) Appl. No.: 14/171,257

(22) Filed: Feb. 3, 2014

Related U.S. Application Data
(60) Provisional application No. 61/909,900, filed on Nov. 27, 2013.

(51) Int. Cl. G01S 19/07

(52) U.S. Cl. CPC G01S 19/07
USPC 342/357.44

(57) ABSTRACT

Systems and methods for using SBAS delay measurements to mitigate ionospheric error are provided. In an embodiment, an array of ionospheric delay measurements of a GNSS is provided, wherein a pierce point is associated with each delay measurement in the array. Further, at least one first element in the array and at least one second element in the array that has a different pierce point than the at least one first element are selected and it's determined whether the difference between the delay measurement of the at least one first element and the delay measurement of the at least one second element is less than a threshold. A level of inflation of error due to geometric screening techniques is adjusted if the difference between the delay measurement of the at least one first element and the delay measurement of the at least one second element is less than the threshold.

### CROSS-REFERENCE TO RELATED APPLICATIONS

This application claims the benefit of U.S. Provisional Patent Application Ser. No. 61/909,900, filed on Nov. 27, 2013, which is hereby incorporated herein by reference.

### BACKGROUND

Global navigation satellite systems (GNSS) provide aircrafts with navigation support in approach and landing operations. However, since the accuracy and precision requirements are high in these operations, Ground Based Augmentation Systems (GBAS) augment GNSS when an aircraft is near a GBAS Ground Subsystem. GBAS Ground Subsystems, also referred to herein as GBAS stations, augment GNSS receivers by broadcasting pseudorange corrections and integrity information to the aircraft, which helps remove GNSS errors in the aircraft's GNSS receiver. As a result, aircrafts can have more precise approaches, departure procedures, and terminal area operations.

### SUMMARY

Systems and methods for using Space Based Augmentation System delay measurements to mitigate ionospheric error are provided. In at least one embodiment, the method comprises providing an array of ionospheric delay measurements of a global navigation satellite system, wherein a pierce point is associated with each ionospheric delay measurement in the array. Further, at least one first element in the array is selected and at least one second element in the array that has a different pierce point than the at least one first element is selected. Additionally, the method further comprises determining whether the difference between the ionospheric delay measurement of the at least one first element and the ionospheric delay measurement of the at least one second element is less than a threshold; and adjusting a level of inflation of error due to geometric screening techniques if the difference between the ionospheric delay measurement of the at least one first element and the ionospheric delay measurement of the at least one second element is less than the threshold.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a flow diagram of an example of a method that uses SBAS ionospheric delay measurements to mitigate GBAS ionospheric threat and errors.

FIG. 2 is a block diagram of an example of a system incorporating SBAS ionospheric delay measurements to mitigate GBAS ionospheric threats and errors.

FIG. 3A is an example of a grid of ionospheric delay measurements.

FIG. 3B is an example of a numerical table of ionospheric delay measurements.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

As discussed above, GBAS augment positioning information given by a GNSS since GNSS can have errors. A major source of error that can occur in a GNSS receiver is due to the signal delay caused by the ionosphere. This error can almost be completely mitigated by the GBAS when the ionosphere is uniform between the aircraft's GNSS receiver and the GBAS station because the GBAS station and the aircraft's GNSS receiver will be experiencing similar signal delays due to the uniformity of the ionosphere. However, when ionospheric disturbances produce a non-uniform ionosphere that results in delay differences in the ionosphere, as observed by the GBAS station's GNSS reference receivers and an aircraft's GNSS receiver, the GBAS station's pseudorange corrections and integrity information as applied to the measurements in the aircraft can be less accurate. This is because of the different delays observed by the GBAS station and the aircraft's GNSS receiver due to the varying delays caused by the ionosphere at each location. Since the integrity of the fault-free output of the airborne receiver is the responsibility of the ground station, the Federal Aviation Administration (FAA) requires that any GBAS be able to mitigate these errors or potential breaches of integrity. This is accomplished through real time estimations of the potential threat to the airborne receiver and bounding the potential threat, which reduces the performance of the GBAS.

To mitigate these errors or potential breaches of integrity, a conventional GBAS could automatically assume the worst case ionospheric gradient is always present. Then, when a GBAS station checks the possible satellite geometry configurations that an approaching aircraft could be using, any satellite geometries that produce an error larger than a tolerable error limit, assuming the worst case ionospheric gradient is present, are broadcast to the aircraft so that they are screened from being used by the aircraft. One such broadcast parameter is the Vertical Ionosphere Gradient standard deviation, also referred to as sigma-vig (σ_{vig}). Typically, σ_{vig} is calculated for a future time based on the satellites that will be in view of the GBAS at a future time. Since satellites orbit the earth twice each sidereal day, over time, different satellites rise and set from the perspective of the GBAS. On every cycle, the calculation of σ_{vig} is performed for a subsequent time epoch for all predicted satellites which will be in view of the GBAS at the future time on all predicted sub-geometries. This real time geometry screening is applicable for protecting all approaches at an airport. The larger the values between the σ_{vig} calculated for one time step in the future, and the σ_{vig} value previously computed for the current time step is broadcast to the GNSS receivers. Making these assumptions can be less advantageous under certain circumstances because assuming worst case ionospheric gradients can degrade performance and availability for CAT-I approach operations and prohibit more advanced operations, such as Category II (CAT-II) approaches or Differential Correction Positing Service (DCPS). Moreover, since the worst case ionospheric conditions in the U.S. have historically been present at a GBAS station once per ten years, making the worst case assumption often results in underutilized resources. This disclosure mitigates this problem by utilizing Space Based Augmentation System (SBAS) data to provide viability and insight to any impending non-uniform ionosphere that threatens the integrity and reduces the accuracy of the GBAS. SBAS is known as Wide Area Augmentation System (WAAS) in the US and the two terms will be used interchangeably throughout this disclosure.

SBAS uses a network of ground-based stations with known fixed positions. These ground-based stations, with highly accurate known positions, calculate the delay from all in view GNSS satellites due to their ionospheric pierce points. After calculating the various delays, the ground based stations transmit this information to master stations, which compute the ionospheric delays using a fixed grid system, then upload the information to SBAS geostationary satellites periodically (approximately every five minutes or more often). The SBAS geostationary satellites then broadcast this array of time delay information to SBAS-enabled GNSS receivers. Note that the terms “an array of ionospheric delay data” and “ionospheric grid point delays” are used interchangeably and “grid points” and “pierce points” are used interchangeably throughout this disclosure.

As stated above, this disclosure takes advantage of the SBAS information to improve the accuracy and integrity of GBAS. In particular, a GBAS can use the array of ionospheric delay data provided by SBAS to determine if the potential for an ionospheric storm gradient exists. Uniformity of the ionospheric delays for various pierce points across a region relates inversely to the risk of ionospheric gradients and large irregularities impacting GBAS served operations. Using the SBAS information over more pierce points, a GBAS station can determine if the ionosphere is affecting the delays measured by the GBAS station and an aircraft's GNSS receiver differently. If the difference between the ionospheric delays experienced by a GBAS station and an aircraft's GNSS receiver is below a threshold, the geometric screening and σ_{vig} inflation techniques used in conventional GBAS can be suspended and more advanced operations can be performed.

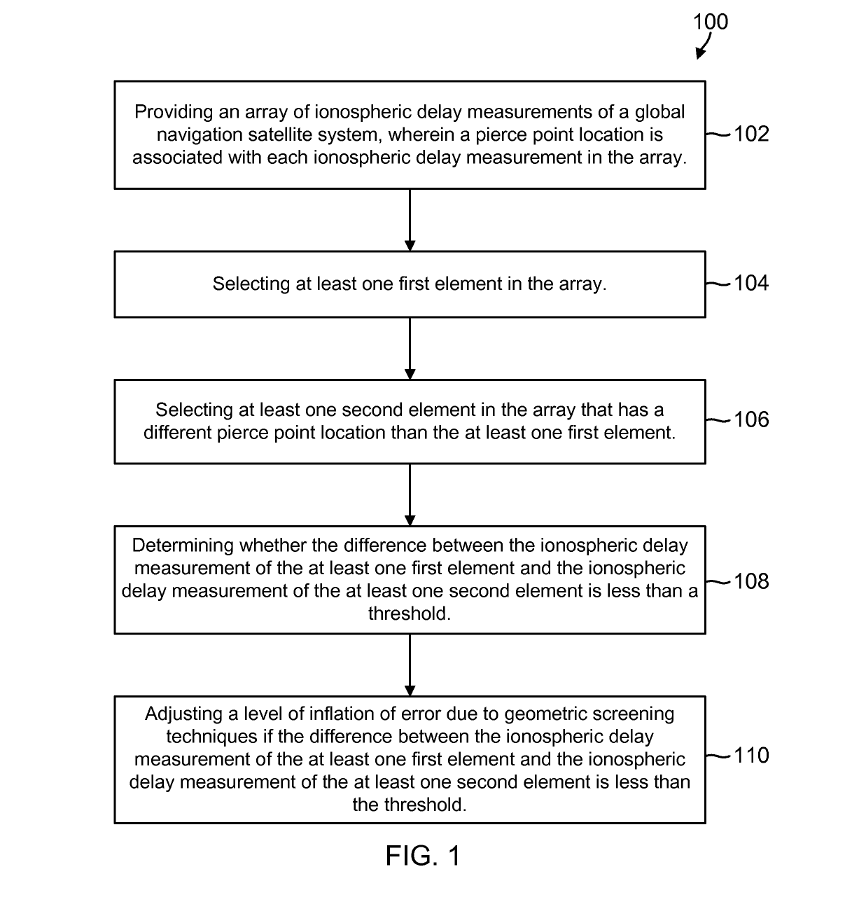

FIG. 1 is a flow diagram of an example of a method 100 for using SBAS ionospheric delay measurements to mitigate ionospheric error. Method 100 includes: providing an array of ionospheric delay measurements of a global navigation satellite system, wherein a pierce point is associated with each ionospheric delay measurement in the array (block 102), selecting at least one first element in the array (block 104), selecting at least one second element in the array that has a different pierce point than the at least one first element (block 106), determining whether the difference between the ionospheric delay measurement of the at least one first element and the ionospheric delay measurement of the at least one second element is less than a threshold (block 108), and adjusting a level of inflation of error due to geometric screening techniques if the difference between the ionospheric delay measurement of the at least one first element and the ionospheric delay measurement of the at least one second element is less than the threshold (block 110). In some embodiments, method 100 can be used to improve aircraft navigation and operations. More specifically, method 100 can monitor the ionospheric grid point delays within a region around a GBAS installation and determine whether enhanced operations (e.g., CAT-II and DCPS operations, as known to one having skill in the art) can be performed or whether the inflation of error due to geometric screening techniques can be adjusted, i.e., turned off, on, reduced, increased, etc.

Different systems can perform method 100. In some embodiments, method 100 can be performed by a ground station (e.g., an aircraft operations center) after an aircraft, which intends to perform an enhanced operation (such as a CAT-II approach), requests approval of the enhanced operation from the aircraft's operations center. In some embodiments, this request can be sent using the Aircraft Communications Addressing and Reporting System (ACARS). After receiving the request, the aircraft's operations center could then perform method 100 and then either accept or reject the request based on results of method 100. In some embodiments, this method 100 could also be integrated into an apparatus within a GBAS ground subsystem. In some implementations of these embodiments, the apparatus within the GBAS ground subsystem could perform method 100 and communicate the operational capability to the approaching aircraft and/or an air traffic controller. In other embodiments, this method 100 could be integrated into an apparatus within an aircraft. In some implementations of these embodiments, the apparatus within the aircraft could perform method 100 when approaching an airport or taking off from an airport.

At block 102, an array of ionospheric delay measurements of a global navigation satellite system is provided, wherein a pierce point is associated with each ionospheric delay measurement in the array. As known to one having skill in the art, the ionosphere is a zone of the atmosphere that extends from about 60 kilometers to 1000 kilometers above the earth's surface and contains a partially ionized medium. The propagation speed of a GNSS signal depends on how ionized the ionosphere is at a given time, which can change over time. The delays in GNSS signals due to the ionosphere can be corrected using GBAS stations with well-known locations. That is, the GBAS station determines the difference in its calculated location using GNSS and its known position. This difference in position can be attributed to the ionosphere. In calculating the delays of GNSS signals due to the ionosphere, the ionosphere can be approximated to be a thin shell that is located approximately 350 kilometers above the earth's surface, instead of being dispersed between 50-1000 kilometers. Using this approximation, the point where the signal travelling between the GNSS satellite and the GBAS station intersects the ionospheric shell is called the ionospheric pierce point. At each of these pierce points, GBAS stations calculate the delay in the GNSS signal, so that each ionospheric delay measurement of a GNSS system is associated with one of these pierce points. As a result, an array of ionospheric delay measurements for GNSS is created.

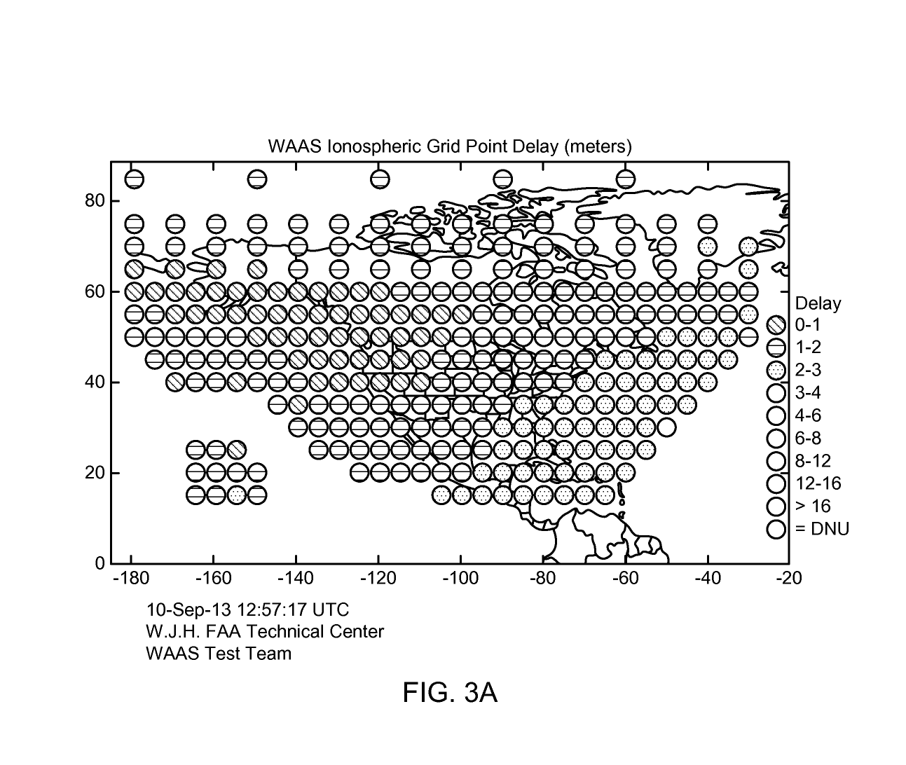

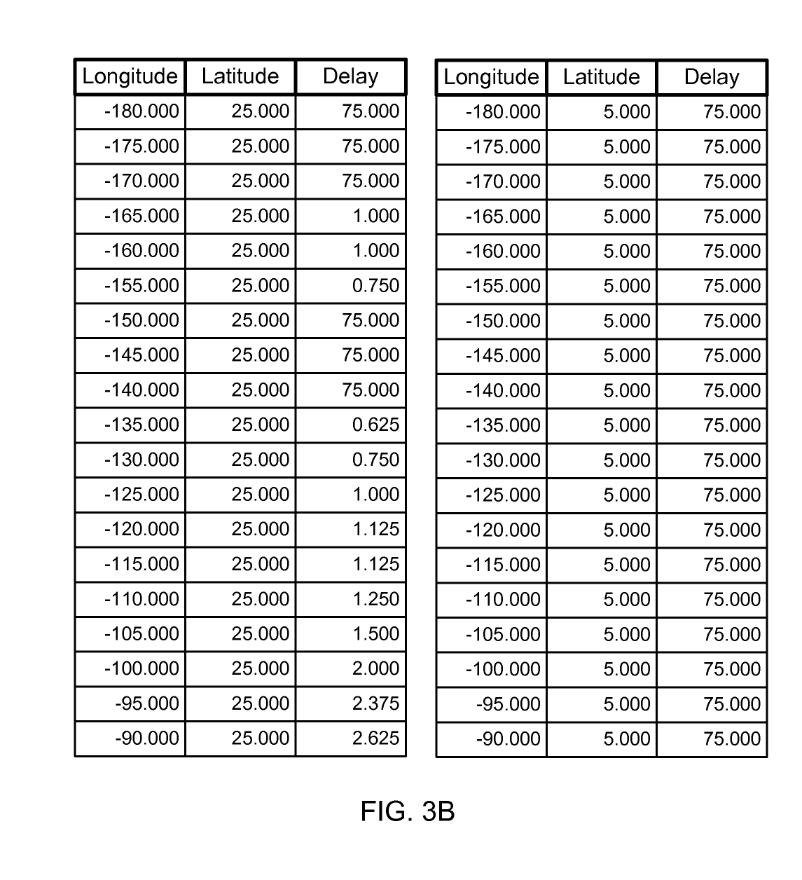

In some embodiments, the array of ionospheric delay measurements can be represented by points on a map. An example of this embodiment is shown in FIG. 3A. FIG. 3A is a chart that illustrates ionospheric grid point delays across a region, which in this case is North America. A real-time graphical presentation of an example of this data can be found by going to the following website http://www.nstb.tc.faa.gov/index.htm and clicking on “WAAS IGP Status”. Each point on the grid corresponds to the ionospheric delay, in meters, that is present at the point, at the time the ionospheric delay was measured. In other embodiments, a table of numerical data of ionospheric grid point delays can be used to represent the array of ionospheric delay measurements. An example of a table of numerical data for ionospheric grid point delays is shown in FIG. 3B. In the table, a position, denoted by a latitude and longitude, is associated with each ionospheric delay measurement. Real time numerical data of an example of this data can be found by going to the following website http://www.nstb.tc.faa.gov/index.htm and clicking on “IGP Delays”.

Next, one or more first elements in the array are selected (block 104). As discussed above, the elements in the array correspond to one or more ionospheric delay measurements, wherein each ionospheric delay measurement has a location associated with it, determined by the GNSS pierce point for the ionospheric delay. There are many different criteria that can be used to determine how the one or more first elements in the array are selected. In some embodiments, the first element that is selected can be based on the pierce point corresponding to that first element. For example, if an aircraft is approaching an airport and would like to determine the ionospheric delay near the airport, one or more first elements with locations in the vicinity of the airport could be selected as the one or more first elements. In other examples, the one or more first elements that are selected can be the elements with locations near a departing airport for an aircraft. In even other embodiments, the one or more first elements that are selected can be the location of a GBAS station. In other embodiments, the one or more first elements that are selected can be the current location of an aircraft when the aircraft is en route to a destination. In addition, only one first element can be selected or more than one first element can be selected.

After one or more first elements are selected, one or more second elements in the array that have different pierce points than the one or more first elements are selected (block 106). Similar to selecting the one or more first elements, the one or more second elements can be selected based on a variety of criteria. In some embodiments, the second elements are selected based on their corresponding pierce points. For example, the second elements that have pierce points within a certain distance of the one or more first elements' pierce points could be selected, e.g., 5 degrees of latitude or within 100 km, etc. Specifically, in an example, all the second elements with pierce points located within 5 degrees of latitude or longitude of the one or more first elements' pierce point could be selected. (Depending on what latitude or longitude the first elements' pierce point is located, 5 degrees of latitude or longitude may correspond to different distances.) In another example, all the second elements with pierce points adjacent to the one or more first elements could be selected. In another embodiment, the second values could be selected based on an expected route of an aircraft. For example, if an aircraft is travelling from Los Angeles, Calif. to San Francisco, Calif., the second elements that could be selected are the ones with pierce point located between Los Angeles and San Francisco. In other embodiments, the second elements could be selected based on an aircraft's current location. That is, the second elements with pierce point located within a certain distance from an en route aircraft could be selected as the second elements. In some embodiments, a combination of the above factors could be used in determining which second elements are selected. For example, the second elements that have ionospheric delay measurements within the same range (e.g., 1-2 meters) as the first elements' ionospheric delay measurements and located with 200 kilometers of the first elements' pierce points could be selected. As mentioned above, these embodiments are only examples and not meant to be limiting.

Next, with respect to method 100, it is determined whether the difference between the ionospheric delay measurement of the at least one first element and the ionospheric delay measurement of the at least one second element is below a threshold (block 108). In some embodiments, the threshold can be set according to a user's preferences. For example, a user might select a threshold as 4-6 meters. That is, whenever the difference in the ionospheric delay measurements of the one or more first elements and the ionospheric delay measurements of the one or more second elements is below 4-6 meters, then the criteria for block 110 is met. In other embodiments, the threshold can be set based on an allowable limit of an ionospheric gradient. For example, the threshold may be set as the maximum allowable limit to enable advanced operations, such as CAT-II approaches or DCPS.

In another embodiment, block 108 may further comprise determining whether the ionospheric delay gradient between the at least one first element and the at least one second element is below a threshold. As an example, a user might select a threshold on the order of hundreds of mm/km, e.g., 100 mm/km, 300 mm/km, etc. That is, for example, whenever the ionospheric delay gradient between the one or more first elements and the ionospheric delay measurements of the one or more second elements is below 100 mm/km, then the criteria for block 110 is met. In an embodiment, the ionospheric gradient is how much the ionospheric delay changes per unit of distance. For example, if the distance between first pierce point and the second pierce point is 100 km and the ionospheric delay is 11 meters at the first pierce point and the ionospheric delay is 2 meters at the second pierce point, then the gradient will be 90 mm/km (9 m/100 km=90 mm/km), which is below the chosen threshold. Similar to above, the threshold for the ionospheric gradient can be based on allowable limit. For example, the threshold may be set as the maximum allowable limit to enable advanced operations, such as CAT-II approaches or DCPS.

Depending on the number of one or more first elements and one or more second elements, determining the difference between the ionospheric delays of the first elements and the ionospheric delays of the second elements can be completed in a number of different ways. In an example where there is only one first element and only one second element, block 108 can entail taking the difference between the ionospheric delay measurement of the first element and the ionospheric delay measurement of the second element and determining whether that difference is below a threshold. In another example where there is only one first element and more than one second element, block 108 can entail taking the difference between the ionospheric delay measurement of the first element and each ionospheric delay measurement of the more than one second elements and determining whether all the differences are below a threshold. Or, in the alternative, where there is only one first element and more than one second elements, block 108 can entail taking the difference between the ionospheric delay measurement of the first element and the ionospheric delay measurement of one of the more than one second elements and determining whether the difference is below a threshold, wherein the one second element is the element in the more than one second elements that has the ionospheric delay measurement which varies from the ionospheric delay measurement of the first element by the greatest amount. For example, if the first element has an ionospheric delay measurement of 1-2 meters and the second elements have ionospheric delay measurements of 0-1 meters, 1-2 meters, 3-4 meters and 9-12 meters, then since the second element that has the ionospheric delay measurement of 9-12 meters varies from the ionospheric delay measurement of the first element (1-2 meters) by the most, it is determined whether the difference between the two is below a threshold. That is, whether a difference of 8-10 meters in ionospheric delay between the first element's pierce point and the second elements' pierce point is below a threshold. The same methods that are applied when there is only one first element and more than one second element can be used when there is only one second element and more than one first element, except applied to the opposite elements. In embodiments where there is more than one first element and more than one second element, block 108 can entail taking the difference between the ionospheric delay measurement of each first element and each second element and determining whether the differences are below a threshold. In other embodiments where there is more than one first element and more than one second element, block 108 can entail taking the difference between the ionospheric delay measurement of one first element and the ionospheric delay measurement of one second element and determining whether the difference is below a threshold, wherein the one first element and the one second element are the elements in the more than one first elements and the more than one second elements, respectively, that have ionospheric delay measurements which vary from each other by the most. For example, if the first elements have ionospheric delay measurements of 1-2 meters, 3-4 meters and 9-12 meters and the second elements have ionospheric delay measurements of 0-1 meters and 1-2 meters, then since the first element that has an ionospheric delay measurement of 9-12 meters varies the most from the second element that has an ionospheric delay measurement of 0-1 meters, it is determined whether the difference in the ionospheric delay measurements of these two elements (i.e., 9-10 meters) is below a threshold. In each of these embodiments, the ionospheric delay gradients between the one or more first elements and the one or more second elements can also be determined using the distances between the pierce points of the one or more first elements and the one or more second elements and the methods described above for calculating the difference in the ionospheric delay measurements.

Next, with respect to method 100, if the difference between the ionospheric delay measurements of the one or more first elements and the ionospheric delay measurements of the one or more second elements is less than a threshold, then the level of inflation of error due to geometric screening techniques is adjusted (block 110). The actions taken to adjust the level of inflation of error due to geometric screening techniques can include, turning the geometric screening techniques “OFF” or “ON”, or reducing or increasing the level of inflation of error, depending on whether it was determined block 108 was below or above a threshold. For example, if the difference between the ionospheric delay measurements of the one or more first elements and the ionospheric delay measurements of the one or more second elements are less than a threshold, the level of inflation of error due to geometric screening techniques could be turned “OFF”. In some embodiments, turning off the inflation of error due to geometric screening techniques includes setting σ_{vig} to a nominal value. In other embodiments, if the difference between the ionospheric delay measurements of the one or more first elements and the ionospheric delay measurements of the one or more second elements is more than a threshold, the level of inflation of error due to geometric screening techniques could be turned “ON”.

In addition to adjusting the level of inflation of error due to geometric screening techniques if the difference between the ionospheric delay measurements of the one or more first elements and the ionospheric delay measurements of one or more second elements is less than a threshold, other actions can be done as well. For example, advanced operations, such as CAT-II approaches, could be requested or performed by an aircraft. In some embodiments, if a CAT-II approach is allowed, the CAT-II operations that were allowed could be provided on a display on a maintenance data terminal (MDT) and/or air traffic status unit (ATSU).

Block 110 may also further comprise adjusting the level of inflation of error due to geometric screening techniques if the ionospheric delay gradients between the one or more first elements and the one or more second elements are less than a threshold. For example, if the ionospheric delay gradients between the one or more first elements and the one or more second elements are less than 100 mm/km, then the level of inflation of error due to geometric screening techniques can be adjusted. Adjusting the level of inflation of error due to geometric screening techniques can include any of the adjustments described above. Further, other actions can be taken as well if the ionospheric delay gradients between the one or more first elements and the one or more second elements are less than a threshold, such as advanced operations like CAT-II approaches and DCPS.

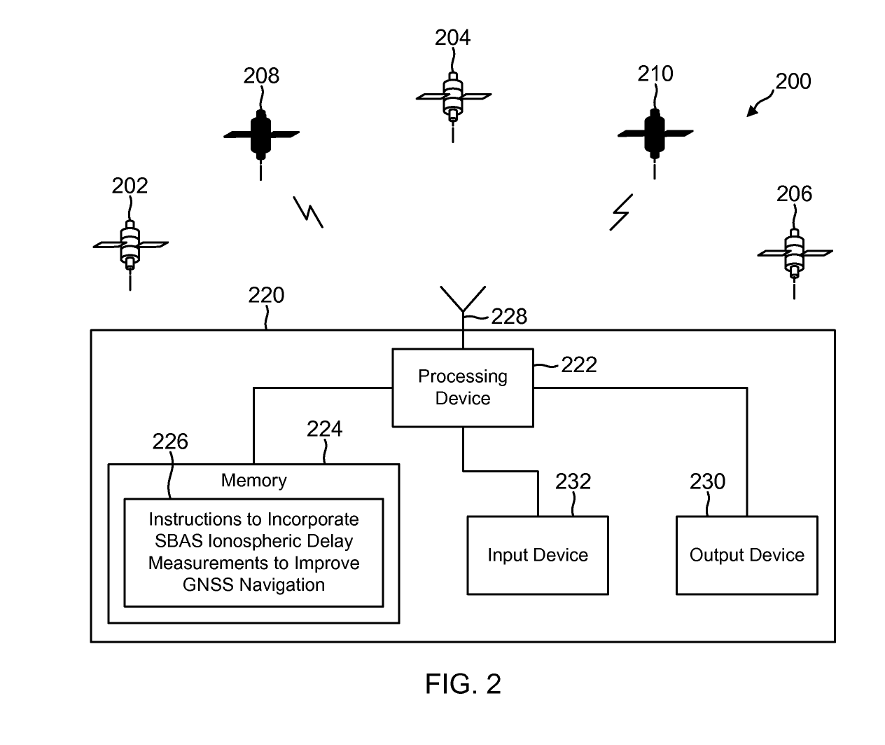

FIG. 2 is a block diagram of an example of a system 200 incorporating SBAS ionospheric delay measurements to mitigate ionospheric error. The system 200 includes an apparatus 220, one or more GNSS satellites 202-206 and one or more SBAS satellites 208-210. As described above, the SBAS satellites 208-210 provide ionospheric delay measurements at each of the ionospheric grid pierce points as shown in FIGS. 3A-3B. This data could be used by the apparatus's 220 processing devices 222 to determine if the ionosphere is uniform, as described in more detail below. In some embodiments, the apparatus 220 can be integrated into the SLS-4000 GBAS. In other embodiments, the apparatus 220 can be integrated into an aircraft's receiver.

The apparatus 220 can include one or more processing devices 222 coupled to one or more memory devices 224. The one or more memory devices 224 can include instructions to incorporate SBAS ionospheric delay measurements to mitigate ionospheric error which, when executed by the one or more processing devices 222, can cause the one or more processing devices 222 to receive an array of ionospheric delay measurements of a GNSS, wherein a location is associated with each ionospheric delay measurement in the array. The one or more processing devices can then select at least one first element in the array, select at least one second element in the array that has a different location than the at least one first element, determine whether the difference between the ionospheric delay measurement of the at least one first element and the ionospheric delay measurement of the at least one second element is less than a threshold, and adjust a level of inflation of error due to geometric screening techniques if the difference between the ionospheric delay measurement of the at least one first element and the ionospheric delay measurement of the at least one second element is less than a threshold. In some embodiments, the one or more processing devices can also determine whether the ionospheric delay gradient between the at least one first element and the at least one second element is less than a threshold, and adjust a level of inflation of error due to geometric screening techniques if the ionospheric delay gradient between the at least one first element and the at least one second element is less than a threshold. These instructions can have some or all of the same functions as the method 100 described above. As used herein, the apparatus 220 is configured to perform a function when the memory 224 includes instructions 226 which, when executed by the processing devices 222, cause the processing device 222 to perform the function.

In addition to the instructions above, the processing device may be further configured to perform other actions, as well. For example, if the difference between the ionospheric delay measurements of the one or more first elements and the ionospheric delay measurements of one or more second elements is less than a threshold, advanced operations, such as CAT-II approaches and DCPS, could be requested or performed. As described with respect to the method 100 above, in some embodiments, if a CAT-II approach is granted by the GBAS ground subsystem, the CAT-II operations that were approved could be provided on a display on a maintenance data terminal (MDT) and/or air traffic status unit (ATSU). In some embodiments, these actions could also be performed if the ionospheric delay gradient between the at least one first element and the at least one second element is less than a threshold.

In an example, the one or more processing devices 222 can include a central processing unit (CPU), microcontroller, microprocessor (e.g., a digital signal processor (DSP)), field programmable gate array (FPGA), application specific integrated circuit (ASIC), or other processing device. The one or more memory devices 224 can include any appropriate processor readable medium used for storage of processor readable instructions or data structures. Suitable processor readable media can include tangible media such as magnetic or optical media. For example, tangible media can include a conventional hard disk, compact disk (e.g., read only or re-writable), volatile or non-volatile media such as random access memory (RAM) including, but not limited to, synchronous dynamic random access memory (SDRAM), double data rate (DDR) RAM, RAMBUS dynamic RAM (RDRAM), static RAM (SRAM), etc.), read only memory (ROM), electrically erasable programmable ROM (EEPROM), and flash memory, etc. Suitable processor-readable media can also include transmission media such as electrical, electromagnetic, and digital signals, conveyed via a communication medium such as a network and/or a wireless link. Moreover, it should be understood that the processor readable media can be integrated into the apparatus 220 as in, for example, RAM, or can be a separate item to which access can be provided to the apparatus 220 as in, for example, portable media such as a compact disk or flash drive.

The apparatus 220 can also include an antenna 228 coupled to the apparatus 220 and configured to sense signals from the satellites 202-210. In an example, the apparatus 220 can include one or more output devices 230 to provide information to a user. The output device 230 can include a display, a speaker, a haptic feedback generator, a light, and other output mechanisms. In an example, the apparatus 220 can include one or more input devices 232. The input device 232 can include a keyboard, mouse, touch sensors, voice sensor, and other input mechanisms. The input device 232 and output device 230 can also include the option for a digital bus interface. In an example, the apparatus 220 can be integrated into a receiver or a larger device such as, for example, the SLS-4000 GBAS Ground Subsystem.

### EXAMPLE EMBODIMENTS

Example 1 includes a method comprising: providing an array of ionospheric delay measurements of a global navigation satellite system, wherein a pierce point is associated with each ionospheric delay measurement in the array; selecting at least one first element in the array; selecting at least one second element in the array that has a different pierce point than the at least one first element; determining whether the difference between the ionospheric delay measurement of the at least one first element and the ionospheric delay measurement of the at least one second element is less than a threshold; and adjusting a level of inflation of error due to geometric screening techniques if the difference between the ionospheric delay measurement of the at least one first element and the ionospheric delay measurement of the at least one second element is less than the threshold.

Example 2 includes the method of Example 1, wherein selecting the at least one first element in the array comprises selecting the at least one first element that has the pierce point closest to a chosen GBAS Ground Subsystem.

Example 3 includes the method of Example 2, wherein selecting the at least one second element in the array that has a different pierce point than the at least one first element comprises selecting all elements with pierce points adjacent to the at least one first element selected.

Example 4 includes the method of any of Examples 2-3, wherein selecting the at least one second element in the array that has a different pierce point than the at least one first element comprises selected all elements with pierce points less than a configurable distance from the at least one first element selected.

Example 5 includes the method of any of Examples 1-4, further comprising determining whether an ionospheric delay gradient between the at least one first element and the at least one second element is below a threshold.

Example 6 includes the method of any of Examples 1-5, wherein adjusting the level of inflation of error due to geometric screening techniques comprises switching off the inflation of error if the difference between the ionospheric delay measurement of the at least one first element and the ionospheric delay measurement of the at least one second element is less than the threshold.

Example 7 includes the method of any of Examples 1-6, wherein adjusting the level of inflation of error due to geometric screening techniques comprises switching on the inflation of error if the difference between the ionospheric delay measurement of the at least one first element and the ionospheric delay measurement of the at least one second element is greater than the threshold.

Example 8 includes the method of any of Examples 1-7, further comprising enabling differential correction position services if the difference between the ionospheric delay measurement of the at least one first element and the ionospheric delay measurement of the at least one second element is less than the threshold.

Example 9 includes the method of any of Examples 1-8, further comprising enabling Category II operations if the difference between the ionospheric delay measurement of the at least one first element and the ionospheric delay measurement of the at least one second element is less than the threshold.

Example 10 includes an apparatus comprising: one or more processing devices; one or more memory devices coupled to the one or more processing devices and including instructions which, when executed by the one or more processing devices, cause the one or more processing devices to: receive an array of ionospheric delay measurements of a global navigation satellite system, wherein a pierce point is associated with each ionospheric delay measurement in the array; select at least one first element in the array; select at least one second element in the array that has a different pierce point than the at least one first element; determine whether the difference between the ionospheric delay measurement of the at least one first element and the ionospheric delay measurement of the at least one second element is less than a threshold; and adjust a level of inflation of error due to geometric screening techniques if the difference between the ionospheric delay measurement of the at least one first element and the ionospheric delay measurement of the at least one second element is less than a threshold.

Example 11 includes the apparatus of Example 10, wherein when the one or more processing devices select the at least one first element in the array the one or more processing devices select the at least one first element that has a pierce point closest to a chosen GBAS Ground Subsystem.

Example 12 includes the apparatus of Example 11, wherein when the one or more processing devices select the at least one second element in the array that has a different pierce point than the at least one first element the one or more processing devices select all elements with pierce points adjacent to the at least one first element selected.

Example 13 includes the apparatus of any of Examples 11-12, wherein when the one or more processing devices select the at least one second element in the array that has a different pierce point than the at least one first element the one or more processing devices select all elements with pierce points less than a configurable distance from the at least one first element selected.

Example 14 includes the apparatus of any of Examples 10-13, wherein the one or more processing devices are further configured to determine whether an ionospheric delay gradient between the at least one first element and the at least one second element is below a threshold.

Example 15 includes the apparatus of any of Examples 10-14, wherein when the one or more processing devices adjusts the level of inflation of error due to geometric screening technique the one or more processing devices switch off the inflation of error if the difference between the ionospheric delay measurement of the at least one first element and the ionospheric delay measurement of the at least one second element is less than a threshold.

Example 16 includes the apparatus of any of Examples 10-15, wherein when the one or more processing devices adjust the level of inflation of error due to geometric screening technique the one or more processing devices switch on the inflation of error if the difference between the ionospheric delay measurement of the at least one first element and the ionospheric delay measurement of the at least one second element is more than a threshold.

Example 17 includes the apparatus of any of Examples 10-16, wherein the processing device is further configured to enable differential correction position services if the difference between the ionospheric delay measurement of the at least one first element and the ionospheric delay measurement of the at least one second element is less than a threshold.

Example 18 includes the apparatus of any of Examples 8-17, wherein the processing device is further configured to enable Category II operations if the difference between the ionospheric delay measurement of the at least one first element and the ionospheric delay measurement of the at least one second element is less than a threshold.

Example 19 includes a program product comprising a processor-readable medium on which instructions are embodied, wherein the program instructions are configured, when executed by at least one programmable processor, to cause the at least one programmable process: to receive an array of ionospheric delay measurements of a global navigation satellite system, wherein a pierce point is associated with each ionospheric delay measurement in the array; to select at least one first element in the array; to select at least one second element in the array that has a different pierce point than the at least one first element; and to determine whether the difference between the ionospheric delay measurement of the at least one first element and the ionospheric delay measurement of the at least one second element is less than a threshold; and to adjust a level of inflation of error due to geometric screening techniques if the difference between the ionospheric delay measurement of the at least one first element and the ionospheric delay measurement of the at least one second element is less than a threshold.

Example 20 includes the computer program product of Example 19, wherein the program instructions are further configured to enable Category II or differential correction position services operations or both if the difference between the ionospheric delay measurement of the at least one first element and the ionospheric delay measurement of the at least one second element is less than a threshold.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method comprising:
providing an array of ionospheric delay measurements of a global navigation satellite system, wherein a pierce point is associated with each ionospheric delay measurement in the array;
selecting at least one first element in the array;
selecting at least one second element in the array that has a different pierce point than the at least one first element;
determining whether the difference between the ionospheric delay measurement of the at least one first element and the ionospheric delay measurement of the at least one second element is less than a threshold; and
adjusting a level of inflation of error due to geometric screening techniques if the difference between the ionospheric delay measurement of the at least one first element and the ionospheric delay measurement of the at least one second element is less than the threshold.

2. The method of claim 1, wherein selecting the at least one first element in the array comprises selecting the at least one first element that has the pierce point closest to a chosen GBAS Ground Subsystem.

3. The method of claim 2, wherein selecting the at least one second element in the array that has a different pierce point than the at least one first element comprises selecting all elements with pierce points adjacent to the at least one first element selected.

4. The method of claim 2, wherein selecting the at least one second element in the array that has a different pierce point than the at least one first element comprises selected all elements with pierce points less than a configurable distance from the at least one first element selected.

5. The method of claim 1, further comprising determining whether an ionospheric delay gradient between the at least one first element and the at least one second element is below a threshold.

6. The method of claim 1, wherein adjusting the level of inflation of error due to geometric screening techniques comprises switching off the inflation of error if the difference between the ionospheric delay measurement of the at least one first element and the ionospheric delay measurement of the at least one second element is less than the threshold.

7. The method of claim 1, wherein adjusting the level of inflation of error due to geometric screening techniques comprises switching on the inflation of error if the difference between the ionospheric delay measurement of the at least one first element and the ionospheric delay measurement of the at least one second element is greater than the threshold.

8. The method of claim 1, further comprising enabling differential correction position services if the difference between the ionospheric delay measurement of the at least one first element and the ionospheric delay measurement of the at least one second element is less than the threshold.

9. The method of claim 1, further comprising enabling Category II operations if the difference between the ionospheric delay measurement of the at least one first element and the ionospheric delay measurement of the at least one second element is less than the threshold.

10. An apparatus comprising:
one or more processing devices;
one or more memory devices coupled to the one or more processing devices and including instructions which, when executed by the one or more processing devices, cause the one or more processing devices to:
receive an array of ionospheric delay measurements of a global navigation satellite system, wherein a pierce point is associated with each ionospheric delay measurement in the array;
select at least one first element in the array;
select at least one second element in the array that has a different pierce point than the at least one first element;
determine whether the difference between the ionospheric delay measurement of the at least one first element and the ionospheric delay measurement of the at least one second element is less than a threshold; and
adjust a level of inflation of error due to geometric screening techniques if the difference between the ionospheric delay measurement of the at least one first element and the ionospheric delay measurement of the at least one second element is less than a threshold.

11. The apparatus of claim 10, wherein when the one or more processing devices select the at least one first element in the array the one or more processing devices select the at least one first element that has a pierce point closest to a chosen GBAS Ground Subsystem.

12. The apparatus of claim 11, wherein when the one or more processing devices select the at least one second element in the array that has a different pierce point than the at least one first element the one or more processing devices select all elements with pierce points adjacent to the at least one first element selected.

13. The apparatus of claim 11, wherein when the one or more processing devices select the at least one second element in the array that has a different pierce point than the at least one first element the one or more processing devices select all elements with pierce points less than a configurable distance from the at least one first element selected.

14. The apparatus of claim 10, wherein the one or more processing devices are further configured to determine whether an ionospheric delay gradient between the at least one first element and the at least one second element is below a threshold.

15. The apparatus of claim 10, wherein when the one or more processing devices adjusts the level of inflation of error due to geometric screening technique the one or more processing devices switch off the inflation of error if the difference between the ionospheric delay measurement of the at least one first element and the ionospheric delay measurement of the at least one second element is less than a threshold.

16. The apparatus of claim 10, wherein when the one or more processing devices adjust the level of inflation of error due to geometric screening technique the one or more processing devices switch on the inflation of error if the difference between the ionospheric delay measurement of the at least one first element and the ionospheric delay measurement of the at least one second element is more than a threshold.

17. The apparatus of claim 10, wherein the processing device is further configured to enable differential correction position services if the difference between the ionospheric delay measurement of the at least one first element and the ionospheric delay measurement of the at least one second element is less than a threshold.

18. The apparatus of claim 8, wherein the processing device is further configured to enable Category II operations if the difference between the ionospheric delay measurement of the at least one first element and the ionospheric delay measurement of the at least one second element is less than a threshold.

19. A program product comprising a processor-readable medium on which instructions are embodied, wherein the program instructions are configured, when executed by at least one programmable processor, to cause the at least one programmable process:
to receive an array of ionospheric delay measurements of a global navigation satellite system, wherein a pierce point is associated with each ionospheric delay measurement in the array;
to select at least one first element in the array;
to select at least one second element in the array that has a different pierce point than the at least one first element; and
to determine whether the difference between the ionospheric delay measurement of the at least one first element and the ionospheric delay measurement of the at least one second element is less than a threshold; and
to adjust a level of inflation of error due to geometric screening techniques if the difference between the ionospheric delay measurement of the at least one first element and the ionospheric delay measurement of the at least one second element is less than a threshold.

20. The computer program product of claim 19, wherein the program instructions are further configured to enable Category II or differential correction position services operations or both if the difference between the ionospheric delay measurement of the at least one first element and the ionospheric delay measurement of the at least one second element is less than a threshold.
